(19) United States
(12) Patent Application Publication
(10) Pub. No.: US 2011/0011383 A1
(43) Pub. Date: Jan. 20, 2011

(54) GLOW PLUG FOR A DIESEL ENGINE

(75) Inventor: Stefano CASSANI, Torino (IT)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/837,120

(22) Filed: Jul. 15, 2010

(30) Foreign Application Priority Data
Jul. 17, 2009 (GB) 0912412.4

(51) Int. Cl. F02P 3/05; F23Q 7/00

(52) U.S. Cl. 123/623; 123/145 A

(57) ABSTRACT

A method for using a glow plug in a diesel engine includes, but is not limited to a first step of providing an electrical energy source for supplying an electrical current through the glow plug, a second step of measuring the electrical current, a third step of calculating a voltage across the glow plug using a measured value of the electrical current, and a fourth step of controlling the electrical current through the glow plug using the calculated voltage.

### CROSS-REFERENCE TO RELATED APPLICATION

This application claims priority to British Patent Application No. 0912412.4, filed Jul. 17, 2009, which is incorporated herein by reference in its entirety.

### TECHNICAL FIELD

The present application relates to a method for using a glow plug in a diesel engine. The present application further relates to a glow plug control unit for operating the glow plug. The present application also relates to a method of making the glow plug control unit.

### BACKGROUND

A glow plug acts as a heating device that is used to warm up cold air in a diesel engine for more efficient ignition. Typically, the glow plug is designed to reach a target temperature of about 1000 degree Celsius (° C.) for the ignition. However, in practice, it is desirable to control electric energy flow to the glow plug to attain the target temperature swiftly and accurately.

### SUMMARY

Embodiments of the application provide an improved method for using or operating a glow plug in a diesel engine. The diesel engine can utilize petroleum diesel, synthetic diesel, or biodiesel for combustion. The diesel engine comprises an engine body with one or more combustion chambers.

The method comprises a step of providing an electrical energy source for supplying an electrical current through the glow plug. The electrical energy source can comprise a battery. The electrical current is measured. A voltage across the glow plug is then calculated by using a measured value of the electrical current. The voltage across the glow plug is usually lower than that of the electrical energy source. This is because a wiring harness between the electrical energy source and the glow plug causes a voltage drop due to its resistance. The wiring harness includes electrical cables, connectors and other parts that link the electrical energy source to the glow plug.

The electrical current through the glow plug is subsequently controlled by using the calculated voltage. The step of controlling can comprise a step of adjusting a voltage across the glow plug according to a predetermined duty cycle such that a temperature of the glow plug is regulated.

This method provides a swift and accurate temperature control to the glow plug because the method controls the electrical current through the glow plug. Although the wiring harness causes the voltage drop, the electrical current remains the same at the electrical energy source, at the wiring harness and at the glow plug due to their serial connections. The method thus enables accurate regulation of the heating of the glow plug by controlling the electrical current. Moreover, since a resistance of the glow plug increases by three times when the glow plug heats up from 20° C. to a target temperature of 1000° C. in usage, variations of the electrical current will reflect the changes of the resistance. Therefore, the method uses the electric current for the controlling such that effects of the resistance variations of the glow plug and the voltage drop due to the wiring harness can be compensated.

A step of measuring a voltage value of the electric energy source can also be provided by the method. The voltage value can be converted to a voltage of the glow plug according to a mathematical formula. The mathematical formula incorporates the measured voltage of the electrical energy source and a resistance value of the wiring harness as its input factors.

The step of measuring can comprise a step of measuring a voltage across a monitoring resistor of the control circuit. The control circuit is serially connected between the electrical energy source and the glow plug. The electrical current that passes through the monitoring resistor also flows through the glow plug.

The step of adjusting can comprise a step of modulating pulse-width of the electric energy flow to the glow plug. The pulse-width modulation technique can be programmed as a glow plug driver and stored into a semiconductor chip.

The method can also include a step of using a predetermined value of the wiring harness for controlling the electrical current. A resistance of the wiring harness can be accurately measured and stored for calculating the voltage across the glow plug.

The method can further comprise a further step of adjusting the electrical current across the glow plug according to predetermined heat-up voltage values for heating up the glow plug within a predetermined period. The step of adjusting the electrical current results voltage variations across the glow plug. The heat-up voltage values provide limits of the voltage across the glow plug for having a burst of electrical current flow through the glow plug within a short period such that the glow plug can be raised to a high temperature rapidly without excessive heating. The short period is also known as a fast heat-up period. The heat-up voltages can comprise a first voltage of a higher value and a second voltage of a lower value. The short period of the fast heat-up voltage can be broken into multiple stages of different voltages. For example, the glow plug can be charged with a high voltage of 11 Volt for 1.5 Second and a subsequent low voltage of 9 Volt for 0.5 Second. The high voltage can speed up heating of the glow plug.

A step of adjusting the electrical current across the glow plug can be included for maintaining the glow plug at a predetermined temperature. The electrical current is controlled for providing a nominal voltage across the glow plug. The nominal voltage provides sustained electrical current flow through the glow plug when the glow plug is merely kept warm. For example, the glow plug is kept warm when a car with the diesel engine moves downhill.

Embodiments of the application also provide a method for using the diesel engine. The method comprises a step of injecting diesel into the diesel engine and the steps of any of the above-mentioned methods for using a glow plug. Hence, the diesel engine can be more fuel efficient.

A step of diagnosing the glow plug can be included into the method of using the glow plug by measuring electrical current value of the glow plug. The diagnosing technique provides a simple and convenient approach to check the glow plug for regular maintenance of the diesel engine.

Embodiments of the application provide a method for making a glow plug control unit. The method comprises a step of measuring an electric resistance value of a wiring harness of the glow plug for storing into the glow plug control unit. The glow plug control unit can compensate the influence of the wiring harness to accurately control the heating of the glow plug.

A step of measuring an electric resistance value of the wiring harness can be included in the method for making the glow plug control unit. The wiring harness includes wiring between the glow plug and the monitoring resistor. The wiring harness further connects to the monitoring resistor to the electrical energy source. Since a resistance of the wiring affects the electrical current through the glow plug due to its resistance, the glow plug control unit can be programmed to compensate the resistance value of the wire.

The method of making can further comprise a step of measuring electric resistance values of the glow plug at different temperatures. Since the electric resistance values change with the temperatures of the glow plug, the electric resistance values can be used as indicators of the temperatures. Consequently, the glow plug control unit can adjust the electrical current through the glow plug in response to the temperatures by monitoring the resistance values. This method thus can provide accurate electrical current through to the glow plug by responding to the electric resistance values. Life span of the glow plug can be prolonged and the glow plug can have less maintenance during the life span. In practice, corresponding values of the resistances and the temperatures can be preloaded into the glow plug control unit.

Embodiments of the present application provide a glow plug control unit. The glow plug control unit comprises a port for measuring a value of an electrical current through a glow plug, a storage unit for storing a measured electrical current value. The storage unit includes a volatile memory and a non-volatile memory.

The glow plug control unit also comprises a control unit for calculating a voltage of the glow plug using the stored electrical current value and for controlling the electrical current through the glow plug using the calculated voltage. The control unit can comprise a processor and a gate control unit. The processor executes an embedded computer program that incorporates the mathematic formula for calculating the electrical current through the glow plug.

The glow plug control unit can comprise a port for receiving engine operation status of a diesel engine. The engine operation status comprises engine body temperature, crankshaft positions, and cranking speed of the engine. The glow plug control unit can adjust electric energy flow to the glow plug accurately by compensating effects of the wiring harness and of the glow plug's temperature variations.

The glow plug control unit can comprise one or more Metal-Oxide-Semiconductor Field-Effect Transistors (MOSFETs) for pulse-width modulation. The MOSFET is used as an electronic switch that regulates electrical current through the glow plug. The MOSFET provides convenience of being integrated into a semiconductor chip for making a compact glow plug control unit. The MOSFET also has faster response than a relay. Alternatively, a Printed Circuit Board (PCB) can form the glow plug control unit. The glow plug control unit can further be integrated into the ECU.

The control unit can comprise a gate drive unit for modulating pulse-width of the electrical current through the glow plug. Pulse-width modulation (PWM) of the electrical current involves the modulation duty cycle of the electrical current. The PWM technique can be programmed and executed a semiconductor chip in a compact manner.

The glow plug control unit can further comprise a monitoring resistor and a transistor that are serially connected between the electrical energy source and the glow plug. The transistor comprises a MOSFET transistor. The monitoring resistor and the transistor form a control circuit that can be made in the form of an integrated circuit (IC). The IC provides a compact and efficient solution of controlling the glow plug.

A manufacturer can build the glow plug control unit that is powered by a standalone electrical power supply, or integrate the glow plug control unit into an engine control unit (ECU). Both the standalone glow plug control unit and the glow plug control unit integrated ECU can be configured to perform the method of using the glow plug. The step of configuring can be achieved by electric circuit wiring, software programming, or in combination of these.

Embodiments of the application provide a diesel engine. The diesel engine comprises the glow plug inserted inside a combustion chamber of the diesel engine. The diesel engine further comprises an electrical energy source and the glow plug control unit. The glow plug control unit is connected to the glow plug and to the electrical energy source. The glow plug control unit is provided for controlling an electrical current through the glow plug. The glow plug control unit can receive swift and accurate control to the glow plugs for engine combustion.

Embodiments of the application provide a computer program for executing the above-mentioned method of using the glow pug.

### BRIEF DESCRIPTION OF THE DRAWINGS

The present invention will hereinafter be described in conjunction with the following drawing figures, wherein like numerals denote like elements, and

FIG. 1 illustrates a schematic diagram of a glow plug control unit for driving four glow plugs in a four-cylinder diesel engine;

FIG. 2 illustrates a simplified diagram of the glow plug control unit with a first glow plug inside an engine body;

FIG. 3 illustrates a graph of voltages of a first glow plug under a control of a pulse-width modulation (PWM) module of the glow control plug unit;

FIG. 4 illustrates experimental data of a first glow plug plotted in a first chart;

FIG. 5 illustrates experimental data of a first glow plug plotted in a second chart;

FIG. 6 illustrates experimental data of a first glow plug plotted in a third chart; and

FIG. 7 illustrates a schematic diagram of the glow plug control unit.

### DETAILED DESCRIPTION

The following detailed description is merely exemplary in nature and is not intended to limit application and uses. Furthermore, there is no intention to be bound by any theory presented in the preceding background or summary or the following detailed description. Moreover, in the following description, details are provided to describe embodiments of the application. It shall be apparent to one skilled in the art, however, that these embodiments may be practiced without such details.

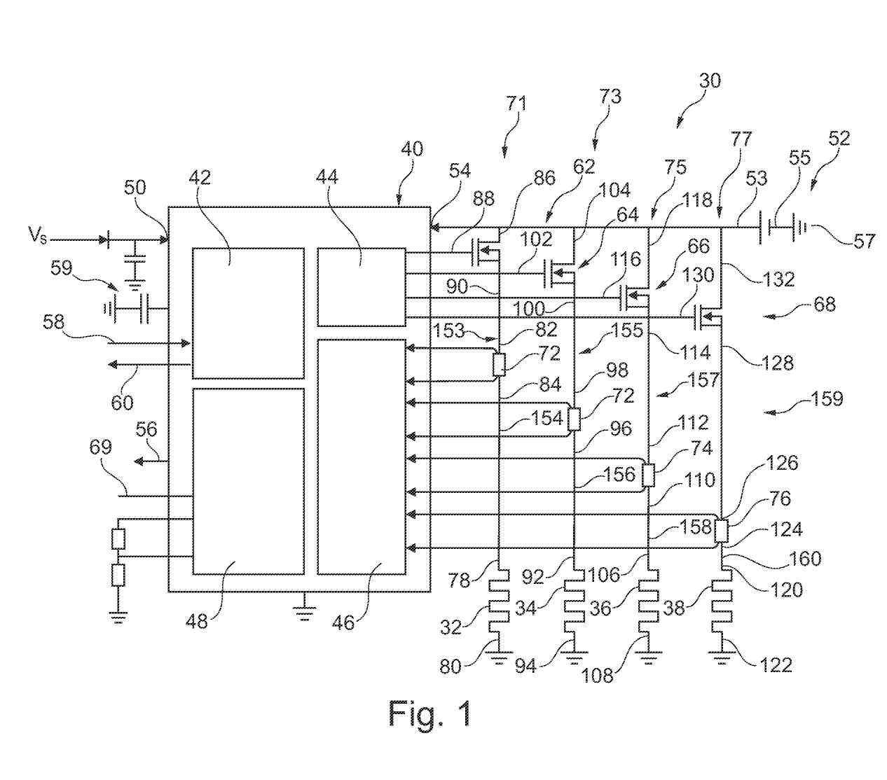

A first embodiment of the present application has been described based on FIGS. 1-7. FIGS. 1-7 comprise parts that have same reference numbers. Relevant description of these parts is incorporated where necessary.

FIG. 1 illustrates a schematic diagram of a glow plug control unit 30 for driving these four glow plugs in a four-cylinder diesel engine. The glow plug control unit 30 is connected to an ECU (Engine Control Unit), which is not shown. The glow plug control unit 30 mainly comprises a PWM (Pulse-Width Modulation) module 40 that is connected to these four glow plugs. These four glow plugs consist of a first glow plug 32, a second glow plug 34, a third glow plug 36, a fourth glow plug 38.

The PWM module 40 comprises a logic unit 42, a gate drive unit 44, a measuring unit 46 and a mode programming unit 48. These four units 42, 44, 46, 48 are interconnected to each other according to a predetermined manner. Each of these four units 42, 44, 46, 48 is also connected to its external electronic components for operation.

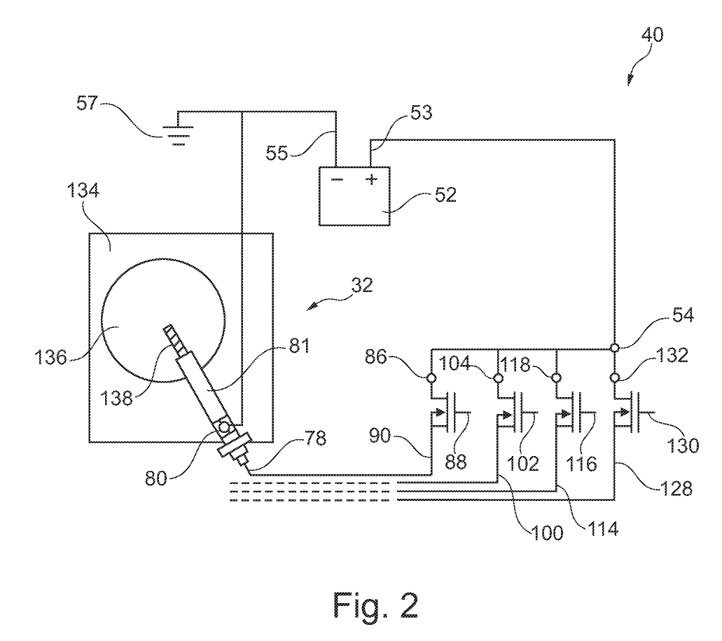

According to FIG. 1, the first glow plug 32, a first monitoring resistor 70, a first MOSFET 62, and the battery 52 are serially connected in sequence. The first MOSFET 62 and the first monitoring resistor 70 form a first control circuit 71. The first glow plug 32 comprises a resistive heating coil with two ends. One of the ends is a first glow plug terminal 78 for receiving an input from the battery 52. The other end is a first ground terminal 80 that is fused to a first casing 81 of the first glow plug 32. The first casing 81 is only visible in FIG. 2.

The first monitoring resistor 70 has a first input terminal 82 and a first output terminal 84 at its opposite ends. The first output terminal 84 joins to the first glow plug terminal 78 and to the measuring unit 46. The first input terminal 82 is connected to the battery 52 via the first MOSFET 62. The first input terminal 82 is also connected to the measuring unit 46.

The first MOSFET 62 is a N-Channel MOSFET that has three terminals. These three terminals are a drain 86, a gate 88 and a source 90. The source 90 is connected to the input terminal 80, the gate 88 is connected to the gate drive unit 44, and the drain 86 is connected to the battery 52.

Similar to the connections of the first glow plug 32, the second glow plug 34, the third glow plug 36 and the fourth glow plug 38 are connected to the battery 52 respectively. In particular, the second glow plug 34 has a second glow plug terminal 92 and a second ground terminal 94. The second glow plug terminal 92 is connected to a second output terminal 96 of the second monitoring resistor 72. The second MOSFET 64 and the second monitoring resistor 72 form a second control circuit 73. A second input terminal 98 of the second monitoring resistor 72 is connected to a source 100 of the second MOSFET 64. A gate 102 of the second MOSFET 64 is connected to the gate drive unit 44, whilst a source 104 of the second MOSFET 64 is connected to the battery 52. Both the second output terminal 96 and the second input terminal 98 are connected to the measuring unit 46 separately.

Electric connections of the third glow plug 36 are similar to those of the first glow plug 32 and the second glow plug 34. The third glow plug 36 has a third glow plug terminal 106 and a second ground terminal 108. The third glow plug terminal 106 is connected to a third output terminal 110 of the third monitoring resistor 74. The third MOSFET 66 and the third monitoring resistor 74 form a third control circuit 75. A third input terminal 112 of the third monitoring resistor 74 is connected to a source 114 of the third MOSFET 66. A gate 116 of the third MOSFET 66 is connected to the gate drive unit 44, whilst a source 118 of the third MOSFET 66 is connected to the battery 52. The third output terminal 110 and the third input terminal 112 are connected to the measuring unit 46 separately.

The fourth glow plug 76 has its electric connections in a way that is similar to that of the first glow plug 32, the second glow plug 34, and the third glow plug 36. The fourth glow plug 38 has a fourth glow plug terminal 120 and a fourth ground terminal 122. The fourth glow plug terminal 120 is connected to a fourth output terminal 124 of the fourth monitoring resistor 76. The fourth monitoring resistor 76 and the fourth MOSFET 68 form a fourth control circuit 77. A fourth input terminal 126 of the fourth monitoring resistor 76 is connected to a source 128 of the fourth MOSFET 68. A gate 128 of the fourth MOSFET 68 is connected to the gate drive unit 44, whilst a source 130 of the fourth MOSFET 68 is connected to the battery 52. The measuring unit 46 is connected to the fourth output terminal 120 and to the fourth input terminal 126 separately.

The PWM module 40 links to a voltage source (Vs) at a voltage input terminal 50 for receiving electric energy. The PWM module 40 is also connected to a battery 52 at a voltage sensing terminal 54 for monitoring voltage value of the battery 52. The battery 52 has a positive output terminal 53 linking to its cathode, and a negative output terminal 55 linking to its anode. In FIG. 1, the negative output terminal 55 connects to ground (GND) 57. The PWM module 40 is further coupled to a low pass filter 59. The PWM module 40 has a relay drive line 56 that connects to other parts of the ECU.

In particular, the logic unit 42 has a control line 58 connected to the ECU for receiving control signals. The logic unit 42 also possesses a diagnosis line 60 linked to the other parts of the ECU for providing diagnosis signals. The gate drive unit 44 and the measuring unit 46 are directly connected to the battery 52, these four MOSFETs (Metal-Oxide-Semiconductor Field-Effect Transistor) 62, 64, 66, 68, these four monitoring resistors 70, 72, 74, 76, and these four glow plugs 32, 34, 36, 38. These components are shown on the right side of FIG. 1. The mode programming unit 48 has an input line 69 for receiving signals that relate to temperature, crankshaft rotation speed, coolant temperature, and other values of the diesel engine.

In the present application, a voltage or a voltage signal can mean a voltage value that describes an electric potential difference between two terminals, or an electric potential at one terminal with respect to an electric ground (GND).

FIG. 2 illustrates a simplified diagram of the glow plug control unit 30 with the first glow plug 32 inside an engine body 134. The engine body 134 has a combustion chamber 136 for receiving fresh air. The first glow plug 32 comprises a first sheath 138 enclosed by a first casing 81 of the first glow plug 32. The first sheath 138 is inserted into the combustion chamber 136, while the first casing 81 is held by the engine body 134.

The engine body 134 has four combustion chambers that receive each of these four glow plugs 32, 34, 36, 38 respectively. These four glow plugs 32, 34, 36, 38 are inserted into these four combustion chambers in similar manners.

Each of the glow plugs 32, 34, 36, 38 has resistive heating coil that comprises a regulating coil and a heating coil for raising temperature of the fresh air inside the combustion chamber 136. These coils heat up the fresh air for ignition with injected diesel.

Each of these four MOSFETs 62, 64, 66, 68 functions as an electronic switch under the control of PWM module 40. Electrical connection between the first drain 86 and the first source 90 is turned on or off by a voltage signal on the first gate 88, which comes from the gate unit 44. Other three MOSFETs 64, 66, 68 are operated similar to that of the first MOSFET 62.

These four monitoring resistors 70, 72, 74, 76 provide voltage signals to the measuring unit 46. These four monitoring resistors 70, 72, 74, 76 also limit electric current flows between the battery 52 and these four glow plugs 32, 34, 36, 38. These four monitoring resistors 70, 72, 74, 76 operate in comparable manners. For example, the first monitoring resistor 70 generates a first input voltage signal at the first input terminal 82. The first monitoring resistor 70 also offers a first output voltage signal at its first output terminal 84. A first resistance value of the first monitoring resistor 70 is predetermined and known to the measuring unit 46. Similarly, the second monitoring resistor 72 generates a second input voltage signal at the second input terminal 98. The second monitoring resistor 72 further provides a second output voltage signal at the second output terminal 96. A second resistance value of the second monitoring resistor 72 is also predetermined and known to the measuring unit 46.

The battery 52 serves as an electric energy source for providing electrical voltage and current to these four glow plugs 32, 34, 36, 38. The voltage source VS supply electricity to the PWM module 40 for its operation. The low pass filter 59 removes low frequency noise of the PWM module 40. The control line 58 provides access from the ECU in order to coordinate operations of these four glow plugs 32, 34, 36, 38. The diagnosis line 60 enables the ECU to check errors of the PWM module 40 for the operations. The relay drive line 56 is optional for regulating an auxiliary glow plug via a relay.

The PWM module 40 mainly governs these four glow plugs 32, 34, 36, 38. In particular, the logic unit 42 provides admittance to the control line 58 and to the diagnosis line 60. The gate unit 44 controls these four gates 88, 102, 116, 130 of these four MOSFETs 62, 64, 66, 68 such that electric energy flow from the battery 52 can be shut off or turned on. The mode programming unit 48 receives electric signals that indicate the diesel engine temperature, crankshaft rotation speed, coolant temperature, and other values.

The glow plugs 32, 34, 36, 38 are low voltage glow plugs that are suitable for controlling by MOSFETs at about 5 Volts. When operated under a PWM scheme, these glow plugs 32, 34, 36, 38 receives a nominal voltage of 5 Volts for fast heat-up to reach the target temperature of 1000° C. from room temperature within 2 seconds. In contrast, a high voltage glow plug requires a nominal voltage of 11 Volts and needs 5-6 seconds to reach the same target temperature. The glow plugs 32, 34, 36, 38 also consume less electrical power as compared to that of high voltage glow plugs. Application of these low voltage glow plugs 32, 34, 36, 38 results in saving of battery power, lowering of wiring harness requirements, and reducing in engine fuel consumption.

The PWM module 40 takes several instant measurement values of these four glow plugs 32, 34, 36, 38 when in use. Besides, the PWM module 40 stores electric resistance values of four wiring harness. These four wiring harnesses connect these four glow plugs 32, 34, 36, 38 to the battery 52.

In particular, the PWM module 40 measures an electric voltage value V_{batt} of the battery 52 at the voltage sensing terminal 54. The PWM module 40 also checks a first electric current value Igp1 of the first glow plug 32. The first electric current value Igp1 can be obtained by checking a voltage across the monitoring resistor 70 of the first control circuit 71. The monitoring resistor 70 is serially connected between the battery 52 and the first glow plug 32. Electric resistance value R_{w1} of a first wiring harness 153 that connects the battery 52 to the first glow plug 32 is calibrated and preloaded into the PWM module 40. The electric resistance R_{w1} of the first wiring harness 153 includes electric resistances of the first MOSFET 62, the first monitoring resistor 70, a first wire 154 between the first monitoring resistor 70 and the first glow plug 32, and other electric connections from the battery 52 to the first glow plug 32. The electric resistance value R_{w1} of a first wiring harness 153 is also known as a predetermined wiring harness electrical resistance R_{w1} that is calibrated by charging the first glow plug 32 at the nominal voltage Vₙₒₘ. The nominal temperature is the target temperature 1000° C. By taking these values, the PWM module 40 is thus able to calculate a first electric voltage value V_{gp1} of the first glow plug 32 according to an formula of (1), as

V_{gp1}=V_{batt}−R_{w1}×I_{gp1} (1)

Using the formula (1), the PWM module 40 controls electric energy flow to the first glow plug 32 by comparing the first electric voltage value V_{gp1} to a predetermined value.

Similarly, the PWM module 40 checks a second electric current value I_{gp2} of the second glow plug 34 at the second output terminal 96, a third electric current value I_{gp3} of the third glow plug 36 at the third output terminal 110, a fourth electric current value I_{gp4} of the fourth glow plug 38 at The fourth output terminal 124. Electric resistances of a second wiring harness 155, of a third wiring harness 157, and of a fourth wiring harness 159 are further calibrated and loaded into the PWM module 40. The PWM module 40 computes a second electric voltage value V_{gp2} of the second glow plug 34, a third electric voltage value V_{gp3} of the third glow plug 36, and a fourth electric voltage value V_{gp4} of The fourth glow plug 38 according to formulas of (2) to (4)

V_{gp2}=V_{batt}−R_{w2}×I_{gp2} (2)

V_{gp3}=V_{batt}−R_{w3}×I_{gp3} (3)

V_{gp4}=V_{batt}−R_{w4}×I_{gp4} (4)

In these formulas of (2) to (4), the R_{w2}, R_{w3} and R_{w4} are calibrated electric resistance values of the second wiring harness 155, of the third wiring harness 157 and of the fourth wiring harness 159 respectively. These wiring harnesses comprise electric connections from the battery 52 to each of these glow plugs 34, 36, 38 respectively.

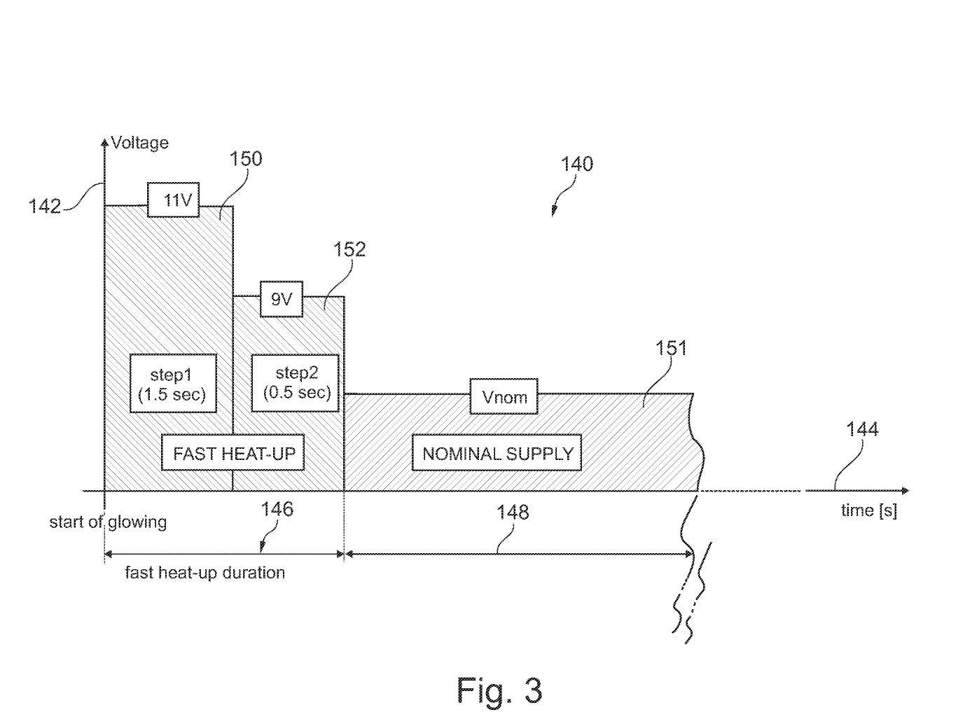

FIG. 3 illustrates a graph of voltages of the first glow plug 32 under a control of the PWM module 40 of the glow control plug unit 30. The other three glow plugs 34, 36, 38 are controlled similar to that of the first low voltage plug 32.

FIG. 3 employs a graph 140 of a two-dimensional Cartesian coordinate that has a vertical axis 142 representing voltage in Volt applied to the first glow plug 32. The graph 140 also has a horizontal axis 144 that represents time in Second. When in use, the glow plug control unit 30 provides two periods of heating to the first glow plug 32. These two periods include a fast heat-up period 146 and a subsequent nominal supply period 148. The fast heat-up period is also known as pre-glow time for speeding up initial rise of temperature in the first glow plug 32 to ignite the diesel engine. In the fast heat-up period 146, the first glow plug 32 is applied with a high voltage Vₕ at 11 Volt for a period of 1.5 Second, which is known as a high voltage stage 150. Afterwards, the first glow plug 32 is charged with a low voltage Vₗ of 9 Volt for 0.5 Second, which is known as a low voltage stage 152. Immediately following the fast heat-up period 146, the first glow plug 32 undergoes a nominal supply period 148 that the first glow plug 32 receives a nominal voltage Vₙₒₘ 151 of 7 Volt for a prolonged period. A total time of the fast heat-up period 146 and the nominal supply period 148 is the duration of cranking cycle of the diesel engine.

The PWM module 40 controls the other glow plugs 34, 36, 38 similar to that of the first low voltage plug 32.

Values of the high voltage Vₕ, the low voltage Vₗ, and the nominal voltage Vₙₒₘ are effective voltages, whilst V_{gp1}, V_{gp2}, V_{gp3}, V_{gp4} are peak voltages across the glow plugs 32, 34, 36, 38. An effective voltage represents a voltage of a constant electrical current that is equivalent to the effect of a pulse-width modulated discontinuous electric current of a higher voltage.

The effective voltages V_{H}, V_{L}, and Vₙₒₘ are determined based on a duty cycle D according to formula (5) below.

$$D = 100 \times \frac{{T}_{on}}{T} = 100 \times \frac{{T}_{on}}{{T}_{on} + {T}_{off}} = 100 \times {( \frac{{V}_{target}}{{V}_{gp}} )}^{2} \qquad ( 5 )$$

In formula (5), Ton and T represent charged time and a total usage time of the glow plug 32, 34, 36, 38. Accordingly, Toff indicates electrical power off time during the total glow plug usage period. V_{target} denotes the effective voltages V_{H}, V_{L} and Vₙₒₘ of FIG. 3, whilst V_{gp} designates peak voltages across these four glow plugs 32, 34, 36, 38 respectively. The glow plug control unit 30 evaluates the duty cycle D in order to achieve the desired effective target voltages V_{target} of a glow plug according to formula (5).

The method of using these four glow plugs 32, 34, 36, 38 is swifter and accurate to achieve the target temperature of 1000° C. at these sheathes of these glow plugs 32, 34, 36, 38. For example, the first glow plug 32 reaches the target temperature 1 second faster than known techniques when heating up from room temperature of 20° C. The first glow plug 32 can also arrive at a peak temperature within 50° C. of the targeted temperature when in use.

The method is used to operate three other glow plugs 34, 36, 38 similar to that of the first glow plug 32. Therefore, these glow plugs 34, 36, 38 also can arrive the target temperature swiftly and accurately.

One of the reasons that the method provides more speedy and precise control for heating these glow plugs 32, 34, 36, 38 is that the glow plug control unit 30 calculate the electric voltage across each glow plug 32, 34, 36, 38 for controlling. The method avoids taking the battery voltage value V_{batt} directly as the voltage received by these glow plugs 32, 34, 36, 38. In fact, these glow plugs 32, 34, 36, 38 do not obtain the whole output voltage of the battery voltage V_{batt} because of the wiring harnesses 153, 155, 157, 159.

The method provides strict temperature control and rapid heating up to these glow plugs 32, 34, 36, 38 because electric resistance values of these glow plugs 32, 34, 36, 38 and wiring harnesses 153, 155, 155, 157 to these glow plugs 32, 34, 36, 38 are calibrated and stored inside the PWM module 40. The calibration takes into account of temperature dependence of the glow plugs 32, 34, 36, 38. For example, the electric resistances of the glow plugs 32, 34, 36, 38 are measured when these glow plugs 32, 34, 36, 38 are supplied with the nominal voltage Vₙₒₘ.

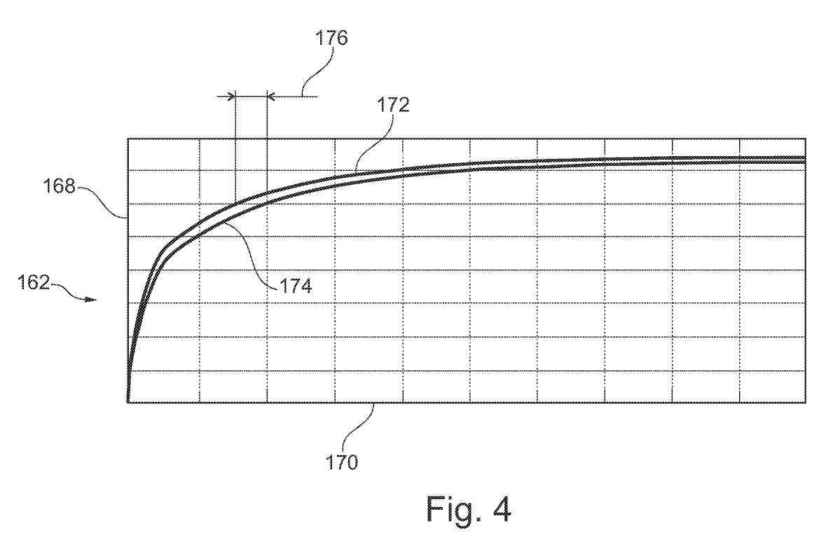

FIGS. 4-6 illustrate experimental data of the first glow plug 32 plotted in three charts.

FIG. 4 illustrates experimental data of the first glow plug 32 plotted in a first chart 162.

The first chart 162 comprises a vertical axis 168 for indicating temperature in Celsius degrees (° C.) and a horizontal axis 170 for indicating time in seconds (S). A first temperature curve 174 represents temperature of the first glow plug 32 heating up from 0° C. by using output voltage of the battery 52 as the voltage of the first glow plug for controlling. A second temperature curve 172 represents temperature of first glow plug 32 heating up from the same starting point 0° C. to the target temperature of 1000° C. by using the voltage across the first glow plug 32 for controlling. The first chart clearly shows that using the voltage across the first glow plug 32 enables the first glow plug 32 to arrive the target temperature faster by 1 S, which compensates the effects of the resistance of the first wiring harness 153. In other words, the first glow plug 32 has been speeded up for warming up and it requires shorter pre-glow time according to the first embodiment. Temperature of the first glow plug 32 is also kept closer to the target temperature 1000° C. by less than 50° C.

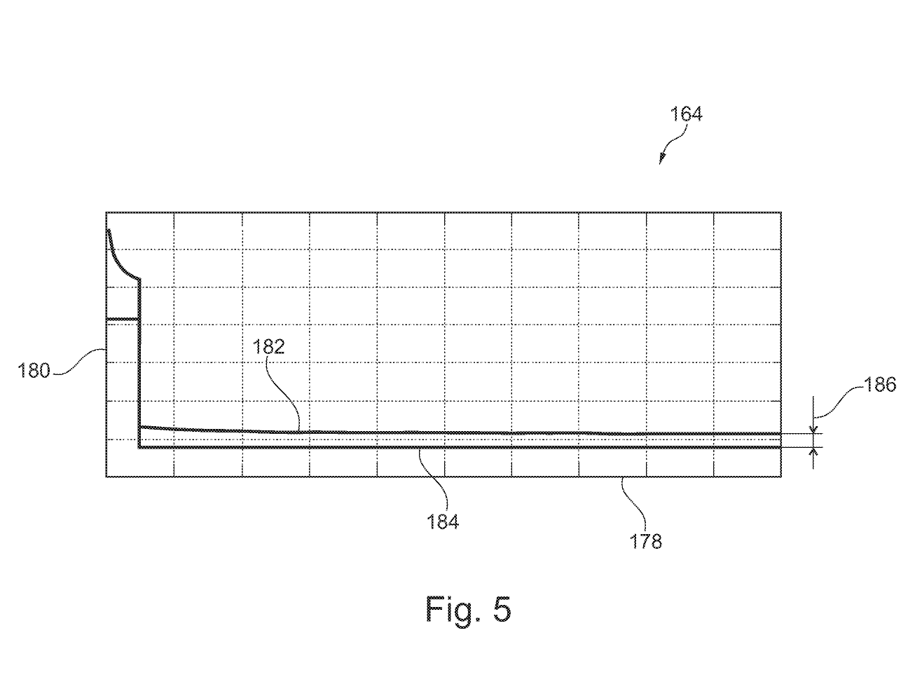

FIG. 5 illustrates experimental data of the first glow plug 32 plotted in a second chart 164. The second chart 164 also displays a horizontal axis 178 for indicating time in seconds (S). The second chart 164 further shows a vertical axis 180 for indicating powering duty percentage of the first glow plug 32. A first duty curve 182 presents a power duty percentage of the first glow plug under a fast heat-up procedure by taking the voltage across the first glow plug 32 for the pulse width modulation. A second duty curve 184 provides a power duty percentage of the first glow plug 32 under a fast heat-up procedure by using the voltage of battery 52 for pulse width modulation. The third chart depicts that there is about 10% difference 186 between the two curves 182, 184.

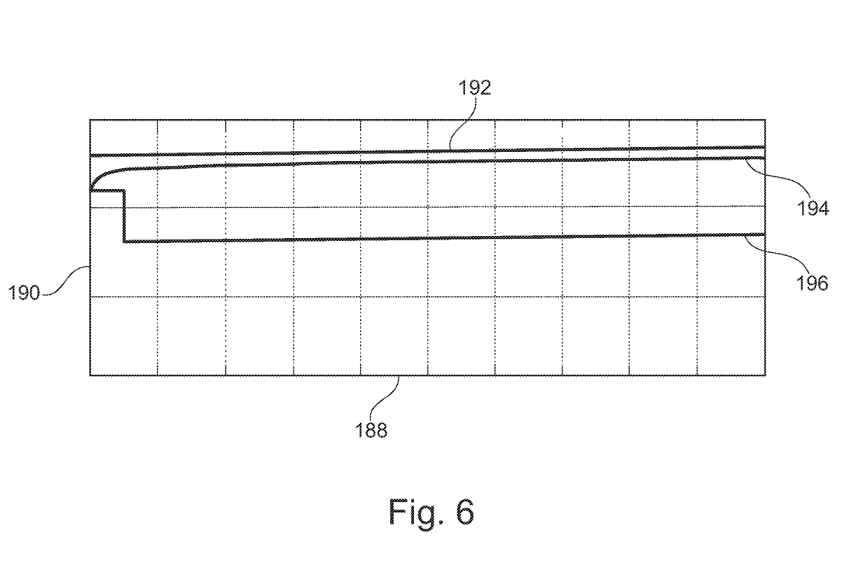

FIG. 6 illustrates experimental data of the first glow plug 32 plotted in a third chart 166. The third chart 166 includes a horizontal axis 188 that displays time in seconds (S). A vertical axis 190 of the third chart 166 represents voltage in Volts. There are three curves in the third chart 166, which consist of a first voltage curve 192, a second voltage curve 194, and a third voltage curve 196. The first voltage curve 192 shows an output voltage of the battery 52, which is a peak voltage available for the PWM. The first voltage curve 192 does not show a true voltage across the glow plug 32 because the first wiring harness 153 causes voltage drop down from the battery 52 to the first glow plug 32. The second voltage curve 194 indicates a peak voltage across the first glow plug 32 for PWM. This peak voltage is the maximum voltage available across the first glow plug 32 for achieving the predetermined effective voltages. The third voltage curve 196 represents the effective voltages across the first glow plug 32 when using the pulse width modulation.

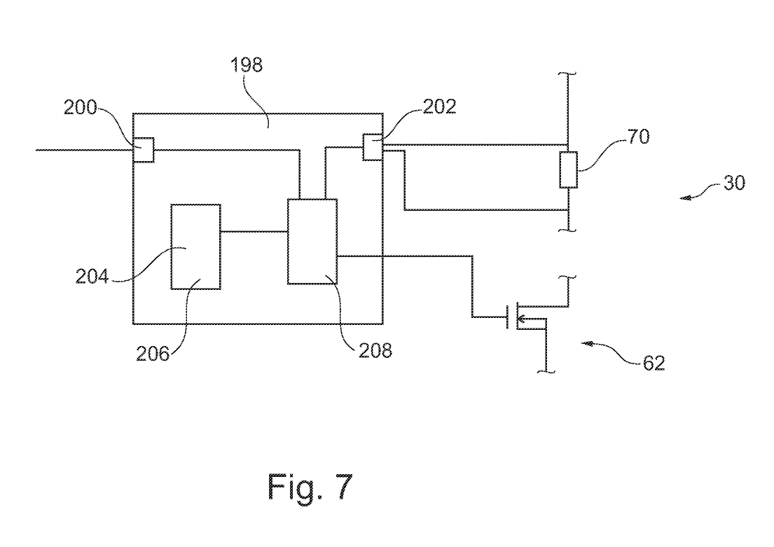

FIG. 7 illustrates a schematic diagram of the glow plug control unit 30. The glow plug control unit 30 is in the form of an integrated semiconductor chip 198 that has several ports and units.

The chip 198 comprises a port 200 that receives engine operation status, including cranking speed signals, engine temperature signals, and throttle position signals. The chip 198 also has a port 202 for measuring electrical values of the monitoring resistor 70. The electrical values contain voltage values and electric current values.

The storage unit 204 encompasses a ROM (read-only memory) and a RAM (Random access memory) that stores measured resistance values of the first glow plug 32 in relation to the various operating temperatures. The storage unit 202 also stores received signals and measured electrical values of the glow plug control unit 30. The storage unit 202 further stores a computer program 206 that is based on the mathematic formula (I) and the heating-up scheme of FIG. 3.

The control unit 208 has a processor that executes the computer program 206 for regulating the first MOSFET 62 in accordance with the stored computer program 206. The control unit 206 is connected to the receiving port 200, the measuring port 202, and the storage unit 204. The control unit 208 modulates the electric current flows through the first glow plug 32 in accordance with the PWM technique.

The present application provides a second embodiment that enables the glow plug control unit 30 to regulate the electric energy flow in response to temperatures of the glow plugs 32, 34, 36, 38 when in use.

In the second embodiment, the measuring unit 46 takes an input electric voltage value V_{R1in} at the first input terminal 82. The measuring unit 46 further checks an output electric voltage value V_{R1out} at the first output terminal 84. The PWM module 40 calculates the first electric current value I_{gp1} that passes through the first glow plug 32 by dividing the difference between the V_{R1in} and the V_{R1out} with an electric resistance value R₁ of the first monitoring resistor 70. The electric resistance value R₁ is measured and preloaded into the PWM module 40. The PWM module 40 further takes resistance value R_{w1} of the first wire 154. A more refined first electric voltage V′_{gp1} of the first glow plug 32 is thus obtained for controlling the first MOSFET 62 according to formula (6) below.

$${V}_{gp 1}^{′} = {V}_{R 1 out} - {R}_{w 1} \times \frac{{V}_{R 1 i n} - {V}_{R 1 out}}{{R}_{1}} \qquad ( 6 )$$

Since the resistance R₁ of the first monitoring resistor 70 and the first wire 154 R_{w1} are normally constant, the PWM module 40 observes the first output voltage V_{R1out} that reflects temperature influence to the first glow plug 32 for precision control. The first output voltage V_{R1out} of the first monitoring resistor 70 can be converted to the voltage V′_{gp1} received by the first glow plug 32 according to the formula (6). Since heating coils of the first glow plug 32 is made of the first glow plug is made of Fr—Cr alloy, its resistance value changes from 80 μΩ at 20° C. to 200 μΩ at 1000° C. The second embodiment avoids taking the resistance of the first glow plug 32 as a constant, which can cause error in control.

Similarly, a more refined second electric voltages V′_{gp2} of the second glow plug 34, a more refined second electric voltages V′_{gp3} of the third glow plug 36, and a more refined fourth electric voltages V_{gp4} of The fourth glow plug 38 can be obtained according to following formulas

$$\begin{matrix}{V}_{gp 2}^{′} = {V}_{R 2 out} - {R}_{w 2} \times \frac{{V}_{R 2 in} - {V}_{R 2 out}}{{R}_{2}} & ( 7 ) \\ {V}_{gp 3}^{′} = {V}_{R 3 out} - {R}_{w 3} \times \frac{{V}_{R3 in} - {V}_{R 3 out}}{{R}_{3}} & ( 8 ) \\ {V}_{gp 4}^{′} = {V}_{R 4 out} - {R}_{w 4} \times \frac{{V}_{R 4 in} - {V}_{R 4 out}}{{R}_{4}} & ( 9 )\end{matrix}$$

In theses formulas, R_{w2} represent electric resistance value of a second wire 156. The second wire 156 connects between the second monitoring resistor 72 and the second glow plug 34. R_{w3} represent electric resistance value of a third wire 158. The third wire 158 connects between the third monitoring resistor 74 and the third glow plug 36. R_{w4} represent electric resistance value of a fourth wire 160. The fourth wire 160 connects between the fourth monitoring resistor 76 and the fourth glow plug 38.

Other mechanical constructions, electric connections and control techniques of the second embodiment are similar to those of the first embodiment.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practice. Thus, the scope of the embodiments should be determined by the claims and their equivalents, rather than by the examples given.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for using a glow plug in a diesel engine, comprising:
supplying an electrical current through the glow plug;
measuring the electrical current;
calculating a voltage across the glow plug using a measured value of the electrical current; and
controlling the electrical current through the glow plug using the voltage.

2. The method of claim 1, further comprising measuring a voltage of an electrical energy source.

3. The method of claim 2, further comprising measuring a voltage across a monitoring resistor, the monitoring resistor connected between the electrical energy source and the glow plug.

4. The method of claim 2, wherein the controlling comprises modulating a pulse-width of the electrical current through the glow plug.

5. The method of claim 2, wherein the calculating comprises using a predetermined wiring harness electrical resistance, the predetermined wiring harness connected between the glow plug and the electrical energy source.

6. The method of claim 1, further comprising adjusting the electrical current across the glow plug according to predetermined heat-up voltage values for heating up the glow plug.

7. The method of claim 6, wherein the heat-up voltage values comprise a first voltage and a second voltage.

8. The method of claim 1, further comprising adjusting the electrical current across the glow plug according to a predetermined nominal voltage value for maintaining the glow plug at a predetermined temperature.

9. A method for making a glow plug control unit, comprising:
measuring a predetermined wiring harness electrical resistance, the predetermined wiring harness electrical resistance comprising electrical connections between an electrical energy source and a glow plug; and
storing the predetermined wiring harness electrical resistance into the glow plug control unit for controlling an electrical current through the glow plug.

10. The method of claim 9, further comprising:
Measuring an electrical resistance values of the glow plug at different temperatures; and
storing the electrical resistance values of the glow plug at different temperatures in the glow plug control unit.

11. A glow plug control unit, comprising:
a port for measuring a value of an electrical current through a glow plug;
a storage unit for storing the value; and
a control unit for calculating a voltage of the glow plug using the value and for controlling the electrical current through the glow plug using the voltage.

12. The glow plug control unit of claim 11, wherein the control unit comprises a gate drive unit for modulating a pulse-width of the electrical current through the glow plug.

13. The glow plug control unit of claim 11, wherein the glow plug control unit further comprises a monitoring resistor and a transistor that are serially connected between an electrical energy source and the glow plug.

14. A diesel engine, comprising
a glow plug inserted inside a combustion chamber of the diesel engine;
an electrical energy source connected to the glow plug; and
a glow plug control unit for controlling an electrical current through the glow plug, the glow plug control unit comprising:
a port for measuring a value of the electrical current through the glow plug;
a storage unit for storing the value; and
a control unit for calculating a voltage of the glow plug using the value and for controlling the electrical current through the glow plug using the voltage value.

15. The diesel engine of claim 14, wherein the control unit comprises a gate drive unit for modulating a pulse-width of the electrical current through the glow plug.

16. The diesel engine of claim 14, wherein the glow plug control unit further comprises a monitoring resistor and a transistor that are serially connected between the electrical energy source and the glow plug.
